(19) United States
(12) Patent Application Publication
(10) Pub. No.: US 2024/0378762 A1
(43) Pub. Date: Nov. 14, 2024

(54) METHODS, SYSTEMS, AND COMPUTER PROGRAM PRODUCTS FOR ASSET IDENTIFICATION AND VISUALIZATION

(71) Applicant: NVIDIA CORPORATION, Santa Clara, CA (US)

(72) Inventors: Ryan Albright, Beaverton, OR (US); Jordan Levy, Portland, OR (US); William Mecham, Elk Grove, CA (US); William Ryan Weese, Portland, OR (US); Benjamin Goska, Portalnd, OR (US); Aaron Carkin, Hillsboro, OR (US); Michael Thompson, Wilsonville, OR (US)

(21) Appl. No.: 18/195,064

(22) Filed: May 9, 2023

(51) Int. Cl. G06T 11/00; H04L 41/22

(52) U.S. Cl. CPC G06T 11/00; H04L 41/22

(57) ABSTRACT

Systems, methods, and computer program products are provided for asset identification and visualization. An example method includes receiving a request for asset visualization that is associated with a plurality of distributed datacenter computing components associated with disparate physical datacenter installations and determining location data for the distributed datacenter computing components. The method further includes generating the asset visualization for presentation to a user associated with the request. The asset visualization is a digital representation of the disparate physical datacenter installations including a visual representation of a presence of the distributed datacenter computing components associated with each disparate physical datacenter installation. The method may render the asset visualization in a virtual reality (VR) environment and/or as an augmented reality (AR) overlay via a user device associated with the user.

### TECHNOLOGICAL FIELD

Embodiments of the present disclosure relate generally to networking and computing systems, and, more particularly, to the identification of distributed datacenter computing assets and the associated generation of asset visualizations that are digital representations of the physical datacenter installations housing these computing assets.

### BACKGROUND

Datacenters, high performance computing clusters, and/or the like are often formed of various datacenter computing components or assets (e.g., graphics processing units (GPUs), servers, racks, switches, etc.) as well as the associated devices (e.g., thermal management systems, cabling, etc.) that enable these components or assets. For example, a physical datacenter installation may be formed of a plurality of racks supporting GPUs each of which may have distinct operational capabilities. Furthermore, these computing components or assets may be disposed at various physical or geographic locations. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure provide for methods, systems, apparatuses, and computer program products for asset identification and visualization. An example method for asset identification and visualization may include receiving a request for asset visualization, wherein the request is associated with a plurality of distributed datacenter computing components associated with disparate physical datacenter installations. The method may include determining location data for the distributed datacenter computing components and generating the asset visualization for presentation to a user associated with the request. The asset visualization may be a digital representation of the disparate physical datacenter installations including a visual representation of a presence of the distributed datacenter computing components associated with each disparate physical datacenter installation.

In some embodiments, the method may further include rendering the asset visualization in a virtual reality (VR) environment.

In some embodiments, the method may further include rendering the asset visualization as an augmented reality (AR) overlay via a user device associated with the user.

In some embodiments, determining the location data may further include receiving one or more transmissions from at least a portion of the distributed datacenter computing components comprising the location data.

In some further embodiments, the visual representation of the presence of the distributed datacenter computing components may be provided in response to the transmission from at least the portion of the distributed datacenter computing components comprising the location data.

In some embodiments, determining the location data may further include accessing intended location data associated with the distributed datacenter computing components

In some embodiments, the visual representation of the presence of the distributed datacenter computing components may include a manipulable digital twin representation of the datacenter computing components.

In some embodiments, a relative positioning between distributed datacenter computing components associated with each disparate physical datacenter installation may be displayed via the asset visualization.

In some embodiments, the method may further include determining one or more performance parameters associated with the distributed datacenter computing components and modifying the asset visualization based upon the one or more performance parameters.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1A illustrates a plurality of distributed datacenter computing components or assets associated with disparate physical datacenter installations in accordance with one or more example embodiments of the present disclosure;

FIG. 1B illustrates example datacenter computing components or assets of the disparate physical datacenter installation of FIG. 1A in accordance with one or more example embodiments of the present disclosure;

FIG. 2 illustrates an example distributed computing system for implementing one or more embodiments of the present disclosure;

FIG. 3 illustrates a block diagram of example server circuitry that may be specifically configured in accordance with an example embodiment of the present disclosure;

FIG. 4 illustrates a flowchart of an example method for asset visualization in accordance with some embodiments of the present disclosure; and

FIG. 5 illustrates a flowchart of an example method for location determination and visualization modification in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As described above, datacenters, high performance computing clusters, and/or the like are often formed of various computing components or assets (e.g., GPUs, servers, racks, switches, etc.), as well as the associated devices (e.g., thermal management systems, cabling, etc.) that enable these components or assets, and each of these components or assets may have distinct operational capabilities. These datacenter computing components or assets are often distributed to various different physical or geographic locations. As such, these disparate physical datacenter installations may be supplied various computing components that should be managed, categorized, monitored, and/or otherwise tracked. Conventional attempts at properly managing these assets, however, have historically required manual data entry by user/operators that is time consuming and error prone. Furthermore, these traditional management systems fail to provide a user-friendly visualization of assets at respective physical locations that is modifiable, in real-time, to account for changes associated with these assets.

In order to solve these problems and others, the embodiments of the present disclosure generate asset visualizations that illustrate the presence (or lack thereof) of distributed datacenter computing components associated with each disparate physical datacenter installation managed by the system. Such a visualization may provide the relative positioning (e.g., geographical distance) between installation/components and may further be rendered in an AR/VR environment in order to allow direct user interaction. For example, the visual representation of the presence of the distributed datacenter computing components may include a manipulatable digital twin representative of the datacenter computing components. Such a digital twin may further illustrate one or more physical attributes, state information, and/or performance parameters of the respective distributed datacenter computing component. In doing so, the embodiments of the present disclosure provide asset visualization methods and systems that may be dynamically modified and updated to account for physical datacenter installation parameters, state, performance, and/or the like.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

### Example Physical Datacenter Installations

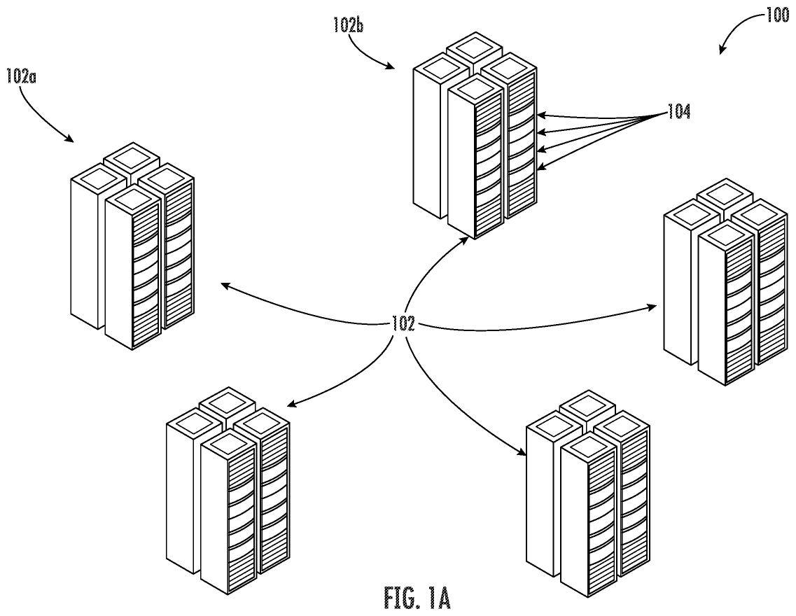

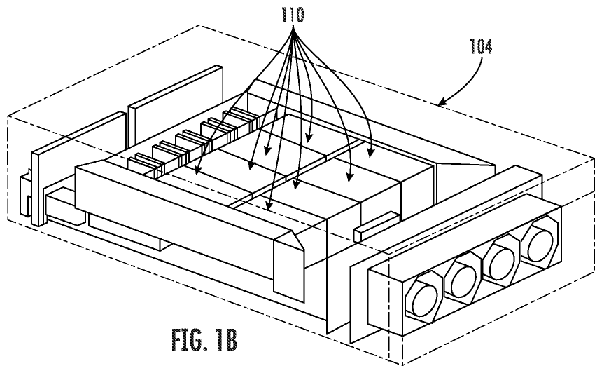

With reference to FIG. 1A, a plurality of distributed datacenter computing components or assets associated with disparate physical datacenter installations 100 is illustrated. As described above, disparate physical datacenter installations 100 may each be formed of a plurality of distributed datacenter computing components or assets (e.g., central processing units (CPUs), data processing units (DPUs), GPUs, servers, racks, switches, etc.). As shown, each of the example disparate physical datacenter installations 100 may include one or more racks 102 supporting or otherwise formed of one or more networking boxes 104 (e.g., servers, computing devices, etc.). As described hereafter with reference to FIG. 1B, the example networking boxes 104 may include various electrical components, optical components, computing devices, etc. (e.g., GPUs 110) for performing the operations associated with each of the disparate physical datacenter installations 100. As described above, these distributed datacenter components may be associated with disparate physical datacenter installations that are located at different physical or geographic locations. By way of example, one or more distributed datacenter computing components may be associated with a first physical datacenter installation 102a at a first physical or geographic location, and one or more distributed datacenter computing components may be associated with a second physical datacenter installation 102b at a second physical or geographic location.

As would be evident by the modular nature of the distributed components forming each of the disparate physical datacenter installations, the arrangement, number, type, etc. of the various datacenter computing components that form each of the disparate physical datacenter installation 100 may vary based upon the number or amount of datacenter computing components (e.g., racks 102, networking/computing boxes 104, GPUs, servers, etc.) and/or the features associated with the installation location (e.g., the size, shape, geometry, etc. associated with the location at which the datacenter is installed). In other words, the present disclosure contemplates that each disparate physical datacenter installation (e.g., the first physical datacenter installation 102a, the physical datacenter installation 102b, . . . etc.) may include one or more of the same or different distributed datacenter computing components based upon the location-specific requirements associated with the particular physical datacenter installation. Furthermore, although described hereinafter with reference to datacenter racks, networking boxes, and/or GPUs, the present disclosure contemplates that the embodiments of the present disclosure may be applicable to any datacenter computing component or asset without limitation. In other words, the present disclosure contemplates that the physical datacenter installations described herein may include any number of components, housings, enclosures, support elements, electrical/optical cabling, thermal management components, etc. based upon the intended application of the particular installation and that these components or assets may each be used to generate the asset visualizations described herein.

As such, and with reference to FIG. 1B, an example networking/computing box 104 is illustrated as an example datacenter computing component of the installation 100. By way of example, the networking/computing box 104 may be a networking enclosure that supports a plurality of GPUs 110 as part of a high-performance computing system. In the example illustrated in FIG. 1B, the example networking/computing box 104 may support eight (8) GPUs 110; however, the present disclosure contemplates that the networking/computing box 104 may support any number of GPUs 110 at any position, location, orientation, etc. based upon the intended application of the installation 100. Although described herein with reference to GPU(s) as example distributed datacenter computing components, the present disclosure contemplates that any device, element, feature, etc. (e.g., CPU, DPU, optical components, switches, and/or the like.) may be used by the installation based upon the intended application of the physical datacenter installation. Furthermore, in order to provide optical and/or electrical connectivity to the datacenter computing components within the example networking/computing box 104, the networking/computing box 104 may include any number of printed circuit boards (PCBs), electrical traces, optical waveguides/fibers, etc. without limitation.

### Example Asset Identification and Visualization Systems

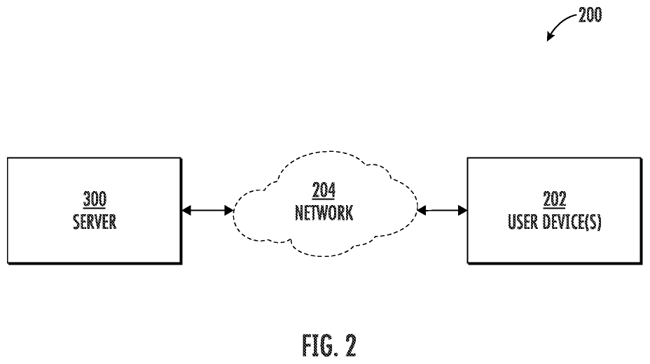

FIG. 2 illustrates an asset visualization system 200 (e.g., system 200) as an example system for generating asset visualizations (e.g., digital twins, digital representations, etc.) of disparate physical datacenter installations. It will be appreciated that the system 200 is provided as an example of an embodiment(s) and should not be construed to narrow the scope or spirit of the disclosure. The depicted system 200 of FIG. 2 may include a server 300 (e.g., an asset visualization server) capable of receiving, generating, accessing, or otherwise generating asset visualizations that are digital representations of the disparate physical datacenter installations including a visual representation of a presence of the distributed datacenter computing components associated with each disparate physical datacenter installation. The server 300 may be further communicatively connected to one or more user device(s) 202 by a communication network 204. For example, the server 300 may be configured to generate an asset visualization as described hereafter and transmit this visualization to one or more user devices 202 for presentation to associated user(s).

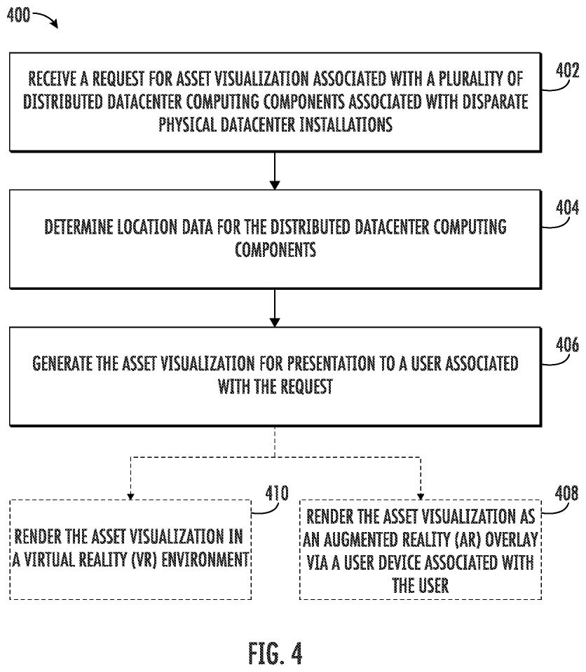

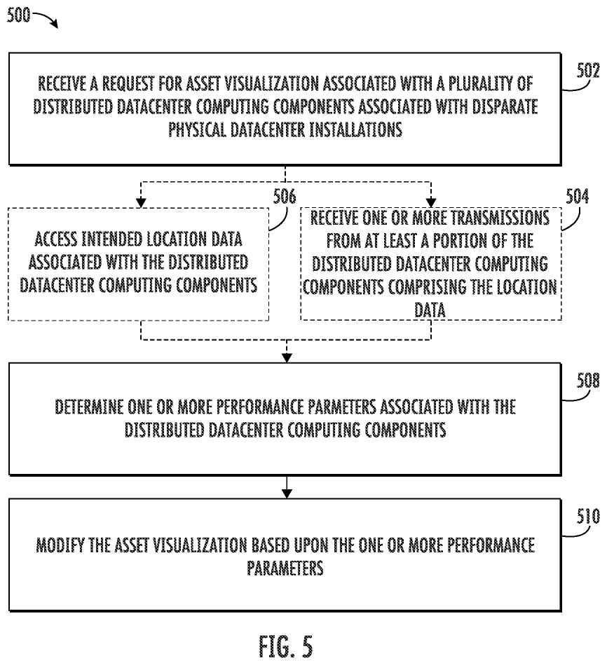

Although described hereinafter with reference to a server 300, the present disclosure contemplates that the operations described hereafter with reference to FIGS. 4-5 may be performed by any computing device, system orchestrator, central processing unit (CPU), graphics processing unit (GPU), data processing unit (DPU), and/or the like. Furthermore, although illustrated as a single device (e.g., server 300), the present disclosure contemplates that any number of distributed components may collectively be used to perform the operations described herein. The server 300 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The system 200 may further include one or more user devices 202 as described above. The one or more user device 202 may refer to computer hardware that is configured (either physically or by the execution of software) to access one or more services made available by the server 300 and, among various other functions, is configured to directly, or indirectly, transmit and receive data. Example user devices may include a smartphone, a tablet computer, a laptop computer, a wearable device (e.g., smart glasses, smart watch, or the like), and the like. In some embodiments, a user device may include a “smart device” that is equipped with chip of other electronic device that is configured to communicate with the external device via Bluetooth, NFC, Wi-Fi, 3G, 4G, 5G, RFID protocols, and the like. By way of a particular example, a user device may be a mobile phone equipped with a Wi-Fi radio that is configured to communicate with a Wi-Fi access point that is in communication with the server 300 or other computing device via a network.

Each user device 202 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware. In some embodiments, one or more of the user devices 202 may be embodied on the same physical device as the server 300. In some embodiments, one or more of the user devices 202 may be remote to the system 200. Still, in some embodiments, one or more user devices 202 may be located on the same physical device as the system 200 and one or more user devices 202 may be remote to the system 200 and connected through the communication network 204.

In some embodiments, as described hereafter with reference to FIG. 4, the asset visualization generated by the server 300 may be rendered in a virtual reality (VR) environment and/or as an augmented reality (AR) overlay via a user device 202 associated with the user. In order to view the VR and/or AR rendering of the asset visualization, in some embodiments, the user device(s) 202 may include circuitry, components, modules, devices, and/or the like. As would be evident to one of ordinary skill in the art, “virtual reality” may refer to any simulated experience within which a user (e.g., a user associated with the user device(s) 202) may be at least partially immersed. For example, a virtual reality rendering may refer to a computer-generated environment within which a user may immersed and with which a user my interact, such as via one or more VR devices (e.g., VR headset, VR mounted displayed, etc.). As would be evident to one of ordinary skill in the art, “augmented reality” may refer to any simulated or interactive experience that includes computer-generated content in conjunction with the real world environment. For example, an augmented reality rendering may refer to computer-generated visual, auditory, and/or other sensor information that is overlayed over a user's (e.g., a user associated with the user device(s) 202) environment. The present disclosure contemplates that the user device(s) 202 may include any component, circuitry, device, etc. configured to render an asset visualization in a VR/AR environment based upon the intended application of the system 200.

The communication network 204 may be any means including hardware, software, devices, or circuitry that is configured to support the transmission of computer messages between system nodes. For example, the communication network 204 may be formed of components supporting wired transmission protocols, such as, digital subscriber line (DSL), Ethernet, fiber distributed data interface (FDDI), or any other wired transmission protocol obvious to a person of ordinary skill in the art. The communication network 204 may also be comprised of components supporting wireless transmission protocols, such as Bluetooth, IEEE 802.11 (Wi-Fi), or other wireless protocols obvious to a person of ordinary skill in the art. In addition, the communication network 204 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 204 may be comprised of any combination of the above mentioned protocols. In some embodiments, such as when the user device(s) 202 and the server 300 are formed as part of the same physical device, the communication network 204 may include the on-board wiring providing the physical connection between the component devices.

### Example Server Circuitry

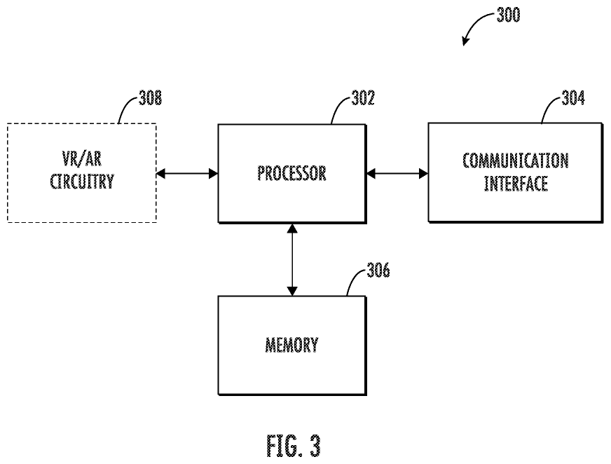

With reference to FIG. 3, example circuitry components of the server 300 are illustrated that may, alone or in combination with any of the components described herein, be configured to perform the operations described herein with reference to FIGS. 4-5. As shown, the server 300 may include, be associated with or be in communication with processor 302, a memory 306, and a communication interface 304. In some embodiments, the server 300 may include VR/AR circuitry 308. The processor 302 may be in communication with the memory 306 via a bus for passing information among components of the server 300. The memory 306 may be non-transitory and may include, for example, one or more volatile and/or non-volatile memories. In other words, for example, the memory 306 may be an electronic storage device (e.g., a computer readable storage medium) comprising gates configured to store data (e.g., bits) that may be retrievable by a machine (e.g., a computing device like the processing circuitry). The memory 306 may be configured to store information, data, content, applications, instructions, or the like for enabling the apparatus to carry out various functions in accordance with an example embodiment of the present disclosure. For example, the memory 306 could be configured to buffer input data for processing by the processor 302. Additionally or alternatively, the memory 306 could be configured to store instructions for execution by the processor 302.

The server 300 (e.g., example apparatus of the present disclosure) may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 302 may be embodied in a number of different ways. For example, the processor 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 302 may be configured to execute instructions stored in the memory 306 or otherwise accessible to the processor 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 302 is embodied as an executor of instructions, the instructions may specifically configure the processor to perform the algorithms and/or operations described herein when the instructions are executed. However, in some cases, the processor 302 may be a processor of a specific device configured to employ an embodiment of the present disclosure by further configuration of the processing circuitry by instructions for performing the algorithms and/or operations described herein. The processor 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In some embodiments, the VR/AR circuitry 308 may include hardware components configured to render an asset visualization as described above. In some embodiments, the asset visualization generated by the server 300 may be rendered by the server 300 for viewing by a user. As such, in such an embodiment, the VR/AR circuitry 308 may include any device, module, component, etc. configured to render the asset visualization. In other embodiments, the one or more muser device(s) 202 may be configured to render the asset visualization in an VR and/or AR environment. As such, in such an embodiment, the server 300 may generate the asset visualization in a format, form, or the like such that, when received by the user device(s) 202, the user device(s) 202 may render the asset visualization for viewing by an associated user. The VR/AR circuitry 308 may utilize processing circuitry, such as the processor 302, to perform its corresponding operations, and may utilize memory 306 to store collected information.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the server 300 may provide or supplement the functionality of particular circuitry.

### Example Methods for Asset Visualization

FIG. 4 illustrates a flowchart containing a series of operations for asset visualization (e.g., method 400). The operations illustrated in FIG. 4 may, for example, be performed by, with the assistance of, and/or under the control of an apparatus (e.g., server 300), as described above. In this regard, performance of the operations may invoke one or more of processor 302, memory 306, communication interface 304, and/or VR/AR circuitry 308.

As shown in operation 402, the apparatus (e.g., server 300) may include means, such as communication interface 304, or the like, for receiving a request for asset visualization. The request received at operation 402 may be associated with a plurality of distributed datacenter computing components of disparate physical datacenter installations, such as illustrated in FIG. 1A. The request for asset visualization may be, for example, associated with the management of datacenter computing components such that the operations of FIG. 4 occur as part of identifying and tracking deployed datacenter computing components. As such, the request received at operation 402 may be received from a user, operator, etc. associated with the management, categorization, tracking, etc. of the distributed datacenter components that form the disparate physical datacenter installations. As described above with reference to FIGS. 1A-1B, each of the disparate physical datacenter installations may be formed of or otherwise include a plurality of distributed datacenter computing components (e.g., racks, switches, GPUs 110, etc.) configured to collectively perform the operations associated with the respective physical datacenter installation. In some embodiments, the request received at operation 402 may be received via a direct user input to the system 200 (e.g., directly to server 300) and/or may be received from a transmission by the user device(s) 202 communicably coupled thereto.

In other embodiments, the request received at operation 402 may occur in response to one or more actions associated with one or more of the distributed datacenter computing components. By way of example and as described hereinafter with reference to FIG. 5, the distributed datacenter computing components may be operably coupled with the system 200 (e.g., with the server 300) such that data transmission may occur therebetween (e.g., via network 204 or the like). As such, for example, one or more of the distributed datacenter computing components may transmit data to the server 300 indicative of the location, presence, state, performance, etc. of the distributed datacenter computing component(s). In such an example, the request received at operation 402 may occur responsive to this received data such that the operations of FIG. 4 occur as part of an iterative and dynamic update procedure of an existing asset visualization. Similarly, the request received at operation 402 may occur in response to the halting or failure of the server 300 to receive a data transmission from one or more of the distributed datacenter computing components. By way of continued example, an asset visualization may exist (e.g., generated by the operations of FIG. 4), and a previously-active distributed datacenter computing component may halt transmission of data to the server 300. In such an example, the request at operation 402 may occur as an iterative or dynamic update to the existing asset visualization that modifies the digital representation of such an inactive distributed datacenter computing component.

Thereafter, as shown in operation 404, the apparatus (e.g., server 300) may include means, such as processor 302, communication interface 304, or the like, for determining location data for the distributed datacenter computing components. As described more fully hereinafter with reference to FIG. 5, the location data described herein may refer to any data entries indicative of or otherwise used to determine the physical or geographic location of the distributed datacenter computing components. In some embodiments, the location data may refer to intended location data associated with the distributed datacenter computing components that may be indicative of the physical or geographic location to which the distributed datacenter computing components were provided. For example, the system 200 (e.g., server 300) may receive data entries from a user, operator, etc. as part of providing (e.g., packing, shipping, transporting, etc.) the distributed datacenter computing components to the intended physical or geographic location. For example, the server 300 may determine intended location data associated with a first physical datacenter installation 102a for one or more distributed datacenter computing components. The present disclosure contemplates that such intended location data, as described hereafter, may further include any physical or geographic location at which the distributed datacenter computing components are located during transport to the physical datacenter installation.

Additionally or alternatively, in some embodiments, the location data determined at operation 404 may be determined based upon one or more transmissions from at least a portion of the distributed datacenter computing components comprising the location data. As described hereafter with reference to FIG. 5, in some embodiments, one or more of the distributed datacenter computing components may be communicably coupled with the system 200 (e.g., the server 300) and transmit data therebetween. In such an embodiment, the location data may be provided as a self-reporting operation by the one or more distributed datacenter computing components of the physical or geographic location. In any of the embodiments described herein, the location data may also be determined at least partially based upon a user input of a physical or geographic location of the distributed datacenter computing component(s) at a particular time. By way of example, a user, device (e.g., camera, scanner, etc.) and/or the like) may provide timestamped data entries indicative of the physical or geographic location of the distributed datacenter computing component(s).

Thereafter, as shown in operation 406, the apparatus (e.g., server 300) may include means, such as processor 302, communication interface 304, or the like, for generating the asset visualization for presentation to a user associated with the request. As described herein, the asset visualization may be a digital representation of the disparate physical datacenter installations including a visual representation of a presence of the distributed datacenter computing components associated with each disparate physical datacenter installation. For example, the asset visualization may refer to a digital rendering, mapping, illustration, image, or other visual representation of the disparate physical datacenter locations and the distributed datacenter computing components employed by these locations. In some embodiments, a relative positioning between distributed datacenter computing components associated with each disparate physical datacenter installation is displayed via the asset visualization. By way of example, the asset visualization may provide an image, chart, map, etc. that, based upon the location data described above, illustrates (e.g., scaled based upon the intended output visual) a relative position between these installations and/or the components. By way of another, non-limiting example, the asset visualization may include a digital rendering of a geographic map that displays the geographic positions of the disparate physical datacenter installations. The present disclosure contemplates that the asset visualization may include any type, format, orientation, configuration etc. associated with digital representations and may further be configured to receive user inputs.

The asset visualization generated at operation 406 may further include a visual representation of the presence of the distributed datacenter computing components. As described above, in some instances, one or more of the distributed datacenter computing components may be communicably coupled with the server 300 and configured to provide location data to the server. Such a transmission may occur periodically by the one or more distributed computing components, in response to a request for location data from the server 300, and/or the like. In such an embodiment, receipt of the location data by the server 300 may indicate that the particular distributed datacenter computing component is present at a particular physical datacenter installation or other such location as defined by the received location data. In such an embodiment, the visual representation of the presence of the distributed datacenter computing components is provided in response to the transmission from at least the portion of the distributed datacenter computing components comprising the location data. Said differently, the asset visualization, in some embodiments, may provide a visual representation (e.g., image, VR/AR object, etc.) that illustrates the location of the distributed datacenter components in response to receipt of the location data from the components.

The visual representation of the presence of the distributed datacenter computing components as described herein may further include a visual representation of the absence of one or more distributed datacenter computing components. By way of continued example, in some embodiments, the server 300 may determine intended location data associated with one or more distributed datacenter components (e.g., the geographic location of the physical datacenter installation at which the component will be employed). As such, upon receipt of the intended location data, the server 300 may provide a visual representation (e.g., image, VR/AR object, etc.) that illustrates the location at which the distributed datacenter components will be employed. In order to distinguish between distributed datacenter computing components that are physically located at the illustrated geographic position (e.g., as determined by self-reported location data or otherwise) and distributed datacenter computing components that are intended to be at particular geographic position, the asset visualization may use various colorings, illuminations, formats, shapes, and/or the like without limitation. By way of a non-limiting embodiments, the absence of a particular distributed datacenter computing component may be illustrated by a dimmed or darkened image while the presence of a particular distributed datacenter computing component may be illuminated or brightened.

In some embodiments, as described more fully hereinafter with reference to FIG. 5, the visual representation of the presence of the distributed datacenter computing components may further include a manipulatable digital twin representative of the datacenter computing components that further illustrates one or more physical attributes, state information, and/or performance parameters of the respective distributed datacenter computing component. By way of example, the rendering or illustration of the disparate physical datacenter installations and/or distributed datacenter computing components may include images, notes, callouts, summaries, and/or other indicators illustrating the processing power, the serviceability, thermal burden, and/or the like associated with various datacenter computing components. In some embodiments, the asset visualization may further include a visual representation of the one or more installation characteristics associated with the physical datacenter installation (e.g., the size, shape, geometry, etc.). By way of example, the digital representation of the physical datacenter installation may include images, notes, callouts, summaries, and/or other indicators illustrating the number/type of datacenter computing components, the relative distance between these components, the thermal management devices servicing these components, and/or the like. Furthermore, the manipulatable digital twin may be configured to receive one or more user inputs interacting with the manipulatable digital twin, such as to select particular distributed datacenter computing components, state information, particular performance parameters, and/or the like.

In some embodiments, as shown in operations 408, 410, the apparatus (e.g., server 300) may include means, such as processor 302, communication interface 304, VR/AR circuitry 308, or the like, for rendering the asset visualization as an augmented reality (AR) overlay via a user device associated with the user and/or rendering the asset visualization in a virtual reality (VR) environment. As described above, virtual reality refers to any simulated experience within which a user (e.g., a user associated with the user device(s) 202) may be at least partially immersed. For example, a virtual reality rendering may refer to a computer-generated environment within which a user may immersed and with which a user my interact, such as via one or more VR devices (e.g., VR headset, VR mounted displayed, etc.). Additionally, augmented reality refers to any simulated or interactive experience that includes computer-generated content in conjunction with the real world environment. For example, an augmented reality rendering may refer to computer-generated visual, auditory, and/or other sensor information that is overlayed over a user's (e.g., a user associated with the user device(s) 202) environment.

By way of example, the asset visualization may, in operation 408, refer to data configured to generate and/or render (by the server 300 alone or with the assistance of the user device(s) 202) an AR overlay that is presented in the user's field of view (FOV) via smart glasses or the like. By way of a particular example, in some instances, the user may be physically located at one or more of the disparate physical datacenter installations. In such an example, the asset visualization may also refer to an AR overlay that presents distributed datacenter computing components at respective locations within the physical location and their associated presence. Additionally or alternatively, the asset visualization may refer to a VR environment in operation 412 within which the user is immersed. In such an example, the VR environment may be configured such that the user is immersed in the digital representation of the physical datacenter installation.

FIG. 5 illustrates a flowchart containing a series of operations for an example method for location determination and visualization modification (e.g., method 500). The operations illustrated in FIG. 5 may, for example, be performed by, with the assistance of, and/or under the control of an apparatus (e.g., server 300), as described above. In this regard, performance of the operations may invoke one or more of processor 302, memory 306, communication interface 304, and/or VR/AR circuitry 308.

As shown in operation 502, the apparatus (e.g., server 300) may include means, such as processor 302, communication interface 304, or the like, for receiving a request for asset visualization associated with a plurality of distributed datacenter computing components associated with disparate physical datacenter installations as described above with reference to operation 402. Thereafter, the apparatus (e.g., server 300) may include means, such as processor 302, communication interface 304, or the like, for accessing intended location data associated with the distributed datacenter computing components as shown in operation 506 and/or receiving one or more transmissions from at least a portion of the distributed datacenter computing components comprising the location data as shown in operation 504.

As described above, the location data of the present disclosure may refer to any data entries indicative of or otherwise used to determine the physical or geographic location of the distributed datacenter components. At operation 506, the location data may refer to intended location data associated with the distributed datacenter computing components that may be indicative of the physical or geographic location to which the distributed datacenter computing components were provided. By way of continued example, the server 300 may receive data entries of from a user, operator, etc. as part of providing (e.g., packing, shipping, transporting, etc.) the distributed datacenter computing components to the intended physical or geographic location. For example, the server 300 may determine intended location data associated with a first physical datacenter installation 102a for one or more distributed datacenter computing components. This intended location data may further include any data generated that is indicative of the time-dependent physical or geographic location of the distributed datacenter component(s). For example, the distributed datacenter computing component(s) may be located at various intermediate locations during transit, and the data generated at these intermediate locations may be provided as intended location data.

As shown in operation 504, in some embodiments, the location data determined at operation 404 may be determined based upon one or more transmissions from at least a portion of the distributed datacenter computing components comprising the location data. As described hereafter with reference to FIG. 5, in some embodiments, one or more of the distributed datacenter computing components may be communicably coupled with the system 200 (e.g., the server 300) and transmit data therebetween. In such an embodiment, the location data may be provided as a self-reporting operation by the one or more distributed datacenter computing components of the physical or geographic location. For example, one or more of the distributed datacenter computing components may periodically transmit data to the server 300 (e.g., location data, state information, performance parameters, status data, and/or the like), and this data may be used to determine the physical or geographic location. As described herein, in some embodiments, the server 300 may periodically request data (e.g., ping or the like) one or more of the distributed datacenter computing components.

Thereafter, as shown in operation 508, the apparatus (e.g., server 300) may include means, such as processor 302, communication interface 304, or the like, for determining one or more performance parameters associated with the distributed datacenter computing components. As would be evident to one of ordinary skill in the art in light of the present disclosure, each of the distributed datacenter computing components (and the disparate physical datacenter installations formed of these components) may have various performance parameters (e.g., processing power, storage/processing utilization, the serviceability, thermal burden, and/or the like) associated with various distributed datacenter computing components as well as the operations performed by these components. Furthermore, the one or more performance parameters may be associated with prior, current, and/or predicted future performance associated with particular distributed datacenter computing components (e.g., a prior, current, or predicted utilization). During operation, these performance parameters may dynamically change due to various environmental constraints, supplied operations, etc. For example, the processing power of a particular disparate physical datacenter installation may vary based upon the presence (e.g., amount) of distributed datacenter computing components employed by this installation.

The one or more performance parameters described herein may further include one or more data entries indicative of the state (e.g., state information) associated with the distributed datacenter computing components. This state information, for example, may be indicative of the connectivity and/or power status associated with a particular distributed datacenter computing component. By way of a non-limiting example, the state information may indicate or otherwise imply that the particular distributed datacenter computing component is powered on, is in standby mode, is powered off, and/or the like. In an instance in which the particular distributed datacenter computing component is a networking-related computing component, the state information may be indicative of the number of ports associated with the computing component, the state or status of the ports (e.g., active, inactive, malfunctioning, on standby, etc.), and/or the like. In some embodiments, the one or more performance parameters and/or state information may include historical data associated with the particular distributed datacenter computing component. For example, the one or more performance parameters and./or state information may include data entries indicative of a duration for which the computing component has been powered on, has been powered off, has been disposed at a particular location, one or more prior physical locations, etc. Furthermore, the one or more performance parameters and/or state information may be indicative of the most recent error, job, task, etc. associated with the particular distributed datacenter computing component. The present disclosure contemplates that any attribute, information, parameter, etc. associated with any of the distributed datacenter computing components described herein may be used/represented by the asset visualizations of the present disclosure.

In order to account for these dynamic changes, as shown in operation 510, the apparatus (e.g., server 300) may include means, such as processor 302, communication interface 304, VR/AR circuitry 308 or the like, for modifying the asset visualization based upon the one or more performance parameters. As described above, the asset visualization may be presented for viewing by a user associated with the request for asset visualization and this visualization (e.g., image, map, graph, rendering, VR/AR rendering, etc.) may include the associated performance parameters, state information, etc. As these parameters change, are updated, etc., the server 300 may be configured to, in real or substantially real-time, modify the asset visualization to reflect these changes in performance parameters, state information, etc. Although described herein with reference to performance parameters, the present disclosure contemplates that the asset visualization may be dynamically or iteratively updated and modified to account for and/or illustrate any change in the disparate physical datacenter installations and/or the distributed datacenter computing components.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

That which is claimed is:

1. A computer-implemented method comprising:
receiving a request for asset visualization, wherein the request is associated with a plurality of distributed datacenter computing components associated with disparate physical datacenter installations;
determining location data for the distributed datacenter computing components; and
generating the asset visualization for presentation to a user associated with the request, wherein the asset visualization is a digital representation of the disparate physical datacenter installations including a visual representation of a presence of the distributed datacenter computing components associated with each disparate physical datacenter installation.

2. The computer-implemented method according to claim 1, further comprising rendering the asset visualization in a virtual reality (VR) environment.

3. The computer-implemented method according to claim 1, further comprising rendering the asset visualization as an augmented reality (AR) overlay via a user device associated with the user.

4. The computer-implemented method according to claim 1, wherein determining the location data further comprises receiving one or more transmissions from at least a portion of the distributed datacenter computing components comprising the location data.

5. The computer-implemented method according to claim 4, wherein the visual representation of the presence of the distributed datacenter computing components is provided in response to the transmission from at least the portion of the distributed datacenter computing components comprising the location data.

6. The computer-implemented method according to claim 1, wherein the visual representation of the presence of the distributed datacenter computing components further comprises a manipulatable digital twin representative of the datacenter computing components that further illustrates one or more physical attributes and/or performance parameters of the respective distributed datacenter computing component.

7. The computer-implemented method according to claim 1, wherein a relative positioning between distributed datacenter computing components associated with each disparate physical datacenter installation is displayed via the asset visualization.

8. The computer-implemented method according to claim 1, further comprising:
determining one or more performance parameters associated with the distributed datacenter computing components; and
modifying the asset visualization based upon the one or more performance parameters.

9. A system comprising:
a non-transitory storage device; and
a processor coupled to the non-transitory storage device, wherein the processor is configured to:
receive a request for asset visualization, wherein the request is associated with a plurality of distributed datacenter computing components associated with disparate physical datacenter installations;
determine location data for the distributed datacenter computing components; and
generate the asset visualization for presentation to a user associated with the request, wherein the asset visualization is a digital representation of the disparate physical datacenter installations including a visual representation of a presence of the distributed datacenter computing components associated with each disparate physical datacenter installation.

10. The system according to claim 9, wherein the processor is further configured to render the asset visualization in a virtual reality (VR) environment.

11. The system according to claim 9, wherein the processor is further configured to render the asset visualization as an augmented reality (AR) overlay via a user device associated with the user.

12. The system according to claim 9, wherein, in determining the location data, the processor is further configured to receive one or more transmissions from at least a portion of the distributed datacenter computing components comprising the location data.

13. The system according to claim 12, wherein the visual representation of the presence of the distributed datacenter computing components is provided in response to the transmission from at least the portion of the distributed datacenter computing components comprising the location data.

14. The system according to claim 9, wherein the visual representation of the presence of the distributed datacenter computing components further comprises a manipulatable digital twin representative of the datacenter computing components that further illustrates one or more physical attributes and/or performance parameters of the respective distributed datacenter computing component.

15. The system according to claim 9, wherein a relative positioning between distributed datacenter computing components associated with each disparate physical datacenter installation is displayed via the asset visualization.

16. The system according to claim 9, wherein the processor is further configured to:
determine one or more performance parameters associated with the distributed datacenter computing components; and
modify the asset visualization based upon the one or more performance parameters.

17. A computer program product comprising at least one non-transitory computer-readable storage medium having computer program code thereon that, in execution with at least one processor, configures the computer program product for:
receiving a request for asset visualization, wherein the request is associated with a plurality of distributed datacenter computing components associated with disparate physical datacenter installations;
determining location data for the distributed datacenter computing components; and
generating the asset visualization for presentation to a user associated with the request, wherein the asset visualization is a digital representation of the disparate physical datacenter installations including a visual representation of a presence of the distributed datacenter computing components associated with each disparate physical datacenter installation.

18. The computer program product according to claim 17, further configured for rendering the asset visualization in a virtual reality (VR) environment and/or rendering the asset visualization as an augmented reality (AR) overlay via a user device associated with the user.

19. The computer program product according to claim 17, wherein a relative positioning between distributed datacenter computing components associated with each disparate physical datacenter installation is displayed via the asset visualization.

20. The computer program product according to claim 17, further configured for:
determining one or more performance parameters associated with the distributed datacenter computing components; and
modifying the asset visualization based upon the one or more performance parameters.
